(19) United States
(12) Patent Application Publication
(10) Pub. No.: US 2020/0349554 A1
(43) Pub. Date: Nov. 5, 2020

(54) SYSTEMS, METHODS, AND STORAGE MEDIA FOR ASSIGNING USER-SPECIFIC BLOCKCHAIN MINING POOL DATA TO A COMPUTING DEVICE

(71) Applicant: Hands-Free Bitcoin, LLC, De Soto, KS (US)

(72) Inventors: Benjamin Adam Simecka, De Soto, KS (US); Austin Nicholas Simecka, De Soto, KS (US)

(21) Appl. No.: 16/858,867

(22) Filed: Apr. 27, 2020

Related U.S. Application Data
(60) Provisional application No. 62/841,178, filed on Apr. 30, 2019.

(51) Int. Cl. G06Q 20/36; G06F 16/2458; G06F 16/23; G06F 9/54; G06Q 20/30; G06Q 40/02

(52) U.S. Cl. CPC G06Q 20/3672; G06F 16/2465; G06F 16/2379; G06F 9/547; G06Q 2220/00; G06Q 20/308; G06Q 40/02; G06F 2216/03; G06Q 20/3676

(57) ABSTRACT

A system, method, and storage media configured for assigning user-specific blockchain mining pool data to a computing device with one or more hardware processors configured by machine-readable instructions that can communicate with one or more remote platforms. The one or more computing platforms are pre-configured with machine-readable instructions to execute at least one or more modules including at least one payout determination module that uses a transformed reward method.

### CROSS-REFERENCE TO RELATED APPLICATIONS

The present invention claims priority to U.S. Provisional Patent Application No. 62/841,178, filed Apr. 30, 2019, herein incorporated by reference in its entirety.

### FIELD OF THE DISCLOSURE

The present relates to systems, methods, and storage media for assigning user-specific blockchain mining pool data to a computing device.

### BACKGROUND

Blockchain cryptocurrency mining (e.g. “mining”, “bitcoin mining”, or “crypto mining”) includes methods of validating blocks of data added to a blockchain, typically resulting in a reward of minted cryptocurrency, transaction fees, or a combination of the two. This is usually accomplished by running a specific algorithm on a computer; either based on a general-purpose chip (a general processor like a CPU or GPU which can run a multitude of scripts) or an ASIC chip (Application Specific Integrated Circuit), which is optimized for one, single script or algorithm. Pool mining is also a standard in which multiple machines, operated by users (workers), are pooled so that their pooled hashing power earns a proportional distribution of the reward. The current options are limited to a few machines produced by a limited number of manufacturers. These prior art machines have many similar issues which present various barriers to entry for new users.

The current options on the market for ASIC miners are generally imported and will only run on 240V AC. This is an issue for anyone in a country (US) that doesn't run on the same power configuration. In the US, as well as other countries, 120V AC is used. In order for someone to mine with an ASIC in a country with 120V standard, they would need to rewire their home to accommodate a 240V circuit. This is not feasible for anyone that is not trained with electricity or without the means to hire a professional electrician.

ASIC miners are generally marketed toward industrial mining farms. The Aesthetics of the hardware are not consumer friendly. There are typically large amounts of exposed, unfinished metals, unfinished fasteners, electronics, fans, and wires. They also, many times, are not enclosed in one protective and convenient enclosure. The exposed wires, fans, and electronics also pose a hazard to handling the hardware as fingers can easily get caught in the high-speed fans, and high-voltage wires and electronics could short-circuit causing electric shock.

In prior art ASIC miners, node programming is not preloaded for the customer. The customer would need to configure and program the miner to actually give them credit for the mining. This is a laborious and knowledge-intensive process. If a customer decides to mine with a pool, they must configure a third-party account for a mining pool, and then load that information onto the ASIC miner through a TCP/IP connection.

Therefore, there exists a need for system and method and that will address the issues with the current market offerings in the bitcoin mining industry.

### SUMMARY

One aspect of the present disclosure relates to a system configured for assigning user-specific blockchain mining pool data to a computing device having one or more computing platforms with electronic storage configured to communicate with one or more remote platforms. The one or more computing platforms can be pre-configured with machine-readable instructions to execute at least one or more module selected from the group consisting of instruction modules, computer program modules, mining pool providing modules, user ID assignment modules, user ID initializing modules, data storing modules, user blockchain wallet account creating modules, user blockchain wallet account using modules, user computing device using modules, user providing modules, and payout determination modules. The at least one payout determination module can have a transformed reward method.

Another aspect of the present disclosure is a non-transitory computer-readable storage medium, configured with instructions executable by one or more processors to cause the one or more processors to assign user-specific blockchain mining pool data to a computing device by; applying a computing device to a computing platform to pre-configure the computing platform with machine-readable instructions that execute at least one or more instruction modules, computer program modules, mining pool providing modules, user ID assignment modules, user ID initializing modules, data storing modules, user blockchain wallet account creating modules, user blockchain wallet account using modules, user computing device using modules, user providing modules, and payout determination modules; connecting the computing device to a central mining pool account with a unique worker ID, wherein hashing power is converted to a reward; determining the unique worker ID contribution to the total combined hashing power through a mining pool API; storing the information gathered on the mining pool API on a job database residing within the computing platform, and determining a reward using a transformed reward method configured to determine confirmed reward payout to a user in an advanced timeframe by dividing the hashrate of a user by the cumulative hashrate of all users at the time of a new confirmed reward, and multiplying the confirmed reward payout by the difference between a new confirmed reward and the previous confirmed reward.

Another aspect of the present disclosure is a method for assigning user-specific blockchain mining pool data to a computing device by performing the steps of; applying a computing device to a computing platform to pre-configure the computing platform with machine-readable instructions that execute at least one or more instruction modules, computer program modules, mining pool providing modules, user ID assignment modules, user ID initializing modules, data storing modules, user blockchain wallet account creating modules, user blockchain wallet account using modules, user computing device using modules, user providing modules, and payout determination modules; connecting the computing device to a central mining pool account with a unique worker ID, wherein hashing power is converted to a reward; determining the unique worker ID contribution to the total combined hashing power through a mining pool API; storing the information gathered on the mining pool API on a job database residing within the computing platform, and determining a reward using a transformed reward method configured to determine confirmed reward payout to a user in an advanced timeframe by dividing the hashrate of a user by the cumulative hashrate of all users at the time of a new confirmed reward, and multiplying the confirmed reward payout by the difference between a new confirmed reward and the previous confirmed reward.

The present disclosure improves functionality of many aspects of the computer and network platform, for example with an improved payout determination module having a transformed reward method. Additionally, the improved functionality of the computer application improves a user's experience with a more timely reward payout to users and more predictable outcomes.

The processor(s) may be configured to provide a mining pool. The processor(s) may be configured to assign a user ID to a user. The processor(s) may be configured to initialize the user ID on the mining pool. The processor(s) may be configured to store user-specific data, including pool-routing information and the user ID, on a user blockchain-mining computing device.

In some implementations, the processor(s) may be configured to create a user blockchain wallet account on a blockchain wallet application linked to the user ID.

In some implementations, the processor(s) may be configured to use the user blockchain wallet account to send and receive payments via a blockchain wallet API.

In some implementations, the processor(s) may be configured to use the user blockchain-mining computing device to mine on the blockchain in a pool of third-party blockchain-mining computing devices by passing data between the pool and the user blockchain-mining computing device via one or more pool-mining APIs.

In some implementations, the pool-routing information may include a pool-mining server address.

In some implementations, the user blockchain-mining computing device may include an Application Specific Integrated Circuit (ASIC).

In some implementations, the user blockchain-mining computing device may include a power supply that can accept voltages within the range of 110-240 volts AC.

In certain embodiments of the invention, an ASIC miner is provided that is optimized for the full spectrum of 110V-240V A/C. This means the ASIC miner can be plugged into any standard outlet in the world in any country, regardless of the power configuration standard. Embodiments of an ASIC miner may include a power supply in the range of about 1000 to 2000 watts designed for a personal computer.

In certain embodiments of the invention, substantially all major components of an ASIC miner are encased within a protective enclosure. The enclosure is designed to have finished surfaces with minimal exposed fasteners. Cooling fans are covered with protective fan covers designed to prevent fingers from impinging on the moving blades. Connection ports are located on the outside of the enclosure, typically including power and internet via RJ45 adapter. Internally, electronics are mounted using flexible tension brackets with shock-absorbing material to minimize damage and prevent movement of internal components. A status-indicating LED is also present on the exterior of the enclosure.

All programming can be pre-configured at the time of purchase. Before an ASIC miner according to the present invention is shipped, the customer's product specific information is loaded onto the machine. A unique ID (user ID) is created during manufacturing of the computing device and assigned to the customer at the time of installation, which can be done using a user ID specific QR code on the device once the user is logged into their account. This connects the customer to the specific computing device that has already been assigned to the mining pool user ID during manufacturing. This allows the customer to simply plug in the power and internet cables and flip the power switch to “on” to begin mining immediately. This can also be done by setting up a unique worker ID on the selected mining pool and then calling the data through an API. Sending funds through an Internet portal of an associated service is accomplished by managing a central wallet and calling data through a separate API.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise. Also, the terms ‘user’, ‘user ID’, and ‘unique worker ID’, and their plural referents are equivalent unless the context clearly dictates otherwise.

### BRIEF DESCRIPTION OF THE DRAWINGS

FIG. 1 illustrates a system configured for assigning user-specific blockchain mining pool data to a computing device, in accordance with one or more implementations.

FIGS. 2A, 2B, 2C, 2D, 2E, 2F, and/or 2G illustrate methods for assigning user-specific blockchain mining pool data to a computing device, in accordance with one or more implementations.

FIG. 3 illustrates a software flowchart for practicing methods according to embodiments of the present invention.

### DETAILED DESCRIPTION

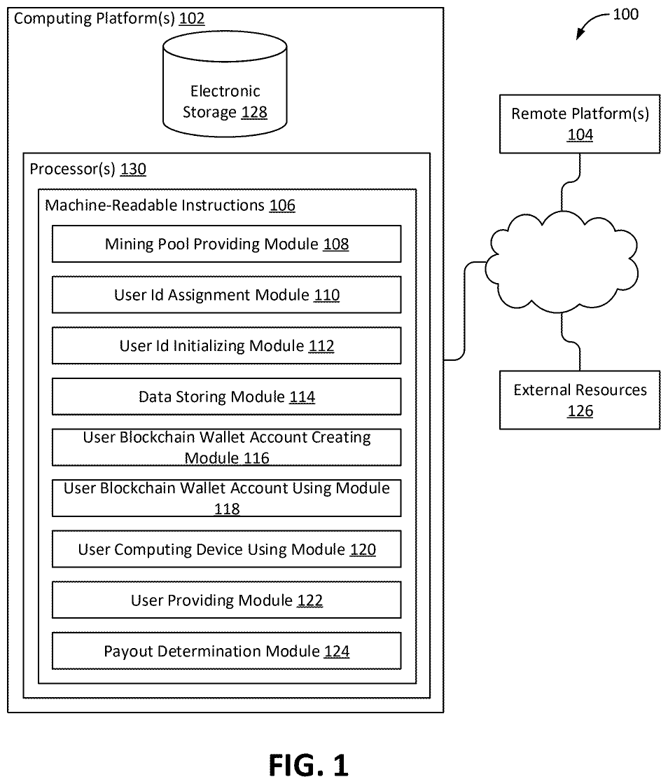

FIG. 1 illustrates a system 100 configured for assigning user-specific blockchain mining pool data to a computing device, in accordance with one or more implementations. In some implementations, system 100 may include one or more computing platforms 102.

Computing platform(s) 102 may be pre-configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be pre-configured by machine-readable instructions 106. Machine-readable instructions 106 may include one or more instruction modules. The instruction modules may include computer program modules. The instruction modules may include one or more of mining pool Providing module 108, user ID assignment module 110, user ID Initializing module 112, data Storing module 114, user blockchain wallet account creating module 116, user blockchain wallet account using module 118, user computing device using module 120, user Providing module 122, payout determination module 124, and/or other instruction modules.

Mining pool providing module 108 may be configured to provide a mining pool. Examples of mining pool protocols are Stratum V1 and Stratum V2 methods of mining operability. The Stratum V2 stack addresses some potential flaws of the current V1 mining protocol by incorporating more choice at the user level to de-centralize the pool level.

User ID assignment module 110 may be configured to assign a user ID to a user. User ID Initializing module 112 may be configured to initialize the user ID on the mining pool.

Data storing module 114 may be configured to store user-specific data, including pool-routing information and the user ID, on a user blockchain-mining computing device. The pool-routing information may include a pool-mining server address. The user blockchain-mining computing device may include an Application Specific Integrated Circuit. The user blockchain-mining computing device may include a power supply that can accept voltages within the range of 110-240 volts AC. The user blockchain-mining computing device may include an approximately 1600 watt power supply.

User blockchain wallet account creating module 116 may be configured to create a user blockchain wallet account on a blockchain wallet Application linked to the user ID.

User blockchain wallet account using module 118 may be configured to use the user blockchain wallet account to send and receive payments via a blockchain wallet API, such as the Square Cash App.

User computing device using module 120 may be configured to use the user blockchain-mining computing device to mine on the blockchain in a pool of third-party blockchain-mining computing devices by passing data between the pool and the user blockchain-mining computing device via one or more pool-mining APIs.

User providing module 122 may be configured to provide a user blockchain-mining computing device including a protective enclosure for enclosing a power supply, one or more fans, and one or more processors.

Payout determination module 124 may be configured to a method of determining payout to a user including the formula of dividing the hashrate of a user by the cumulative hashrate of all users and multiplying the product thereof by the difference between a new confirmed reward and the previous confirmed reward.

Payout determination module 124 may be configured to a method of determining payout to a user including the formula of wherein h1 represents the hashrate of the user, h2 represents the cumulative hashrate of all users, a1 represents the amount of a new confirmed reward. By way of non-limiting example, data collected from the pool-mining API may include the user ID, the hashrate of the user, the cumulative hashrate of all users in the mining pool, and the cumulative confirmed reward. A2 may represent the amount of a previous confirmed reward.

In some implementations, computing platform(s) 102, remote platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 126 may be operatively linked via some other communication media.

A given remote platform 104 may include one or more processors configured to execute computer program modules. The computer program modules may be configured to enable an expert or user associated with the given remote platform 104 to interface with system 100 and/or external resources 126, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Computing platform(s) 102 may include electronic storage 128, one or more processors 130, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 128 may comprise non-transitory storage media that electronically stores information. The electronic storage media of electronic storage 128 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from computing platform(s) 102, information received from remote platform(s) 104, and/or other information that enables computing platform(s) 102 to function as described herein.

Processor(s) 130 may be configured to provide information processing capabilities in computing platform(s) 102. As such, processor(s) 130 may include one or more of a digital processor, an analog processor, a digital Circuit designed to process information, an analog Circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute modules 108, 110, 112, 114, 116, 118, 120, 122, and/or 124, and/or other modules. Processor(s) 130 may be configured to execute modules 108, 110, 112, 114, 116, 118, 120, 122, and/or 124, and/or other modules by software; hardware; firmware; some combination of software, hardware, and/or firmware; and/or other mechanisms for configuring processing capabilities on processor(s) 130. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, and/or 124 are illustrated in FIG. 1 as being implemented within a single processing unit, in implementations in which processor(s) 130 includes multiple processing units, one or more of modules 108, 110, 112, 114, 116, 118, 120, 122, and/or 124 may be implemented remotely from the other modules. The description of the functionality provided by the different modules 108, 110, 112, 114, 116, 118, 120, 122, and/or 124 described below is for illustrative purposes, and is not intended to be limiting, as any of modules 108, 110, 112, 114, 116, 118, 120, 122, and/or 124 may provide more or less functionality than is described. For example, one or more of modules 108, 110, 112, 114, 116, 118, 120, 122, and/or 124 may be eliminated, and some or all of its functionality may be provided by other ones of modules 108, 110, 112, 114, 116, 118, 120, 122, and/or 124. As another example, processor(s) 130 may be configured to execute one or more additional modules that may perform some or all of the functionality attributed below to one of modules 108, 110, 112, 114, 116, 118, 120, 122, and/or 124.

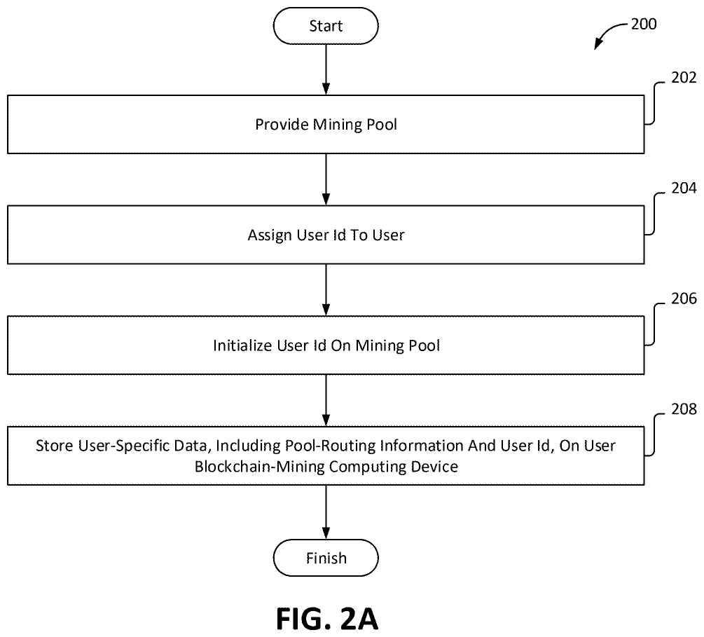

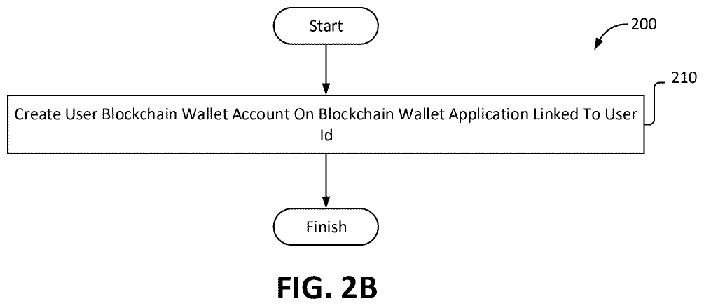

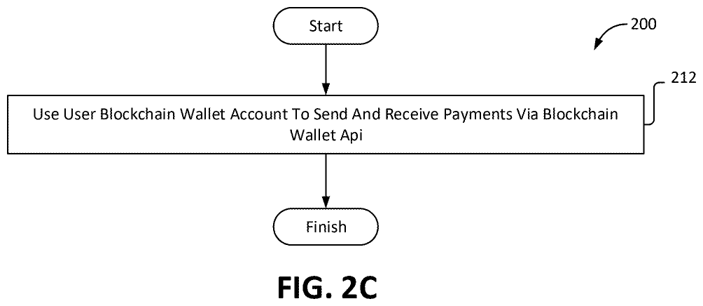

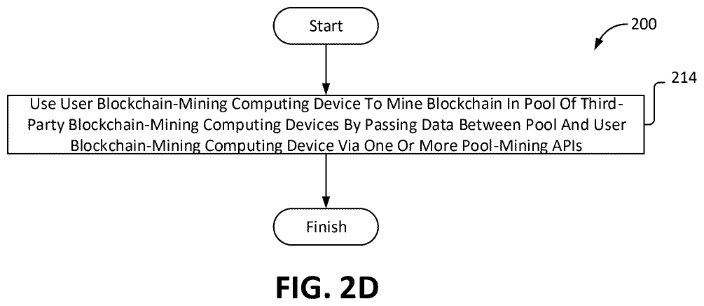

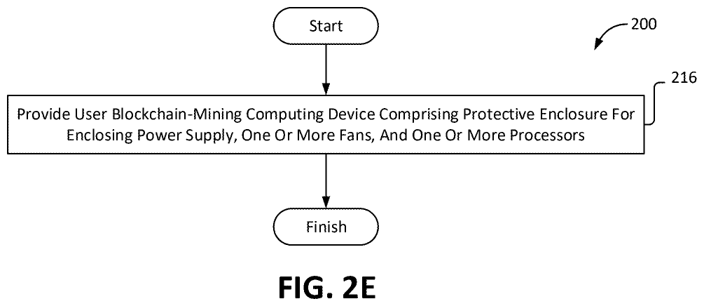

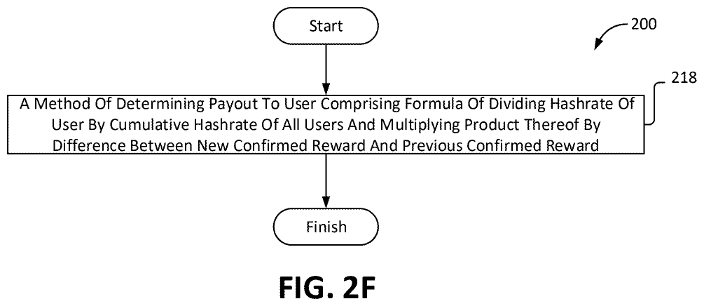

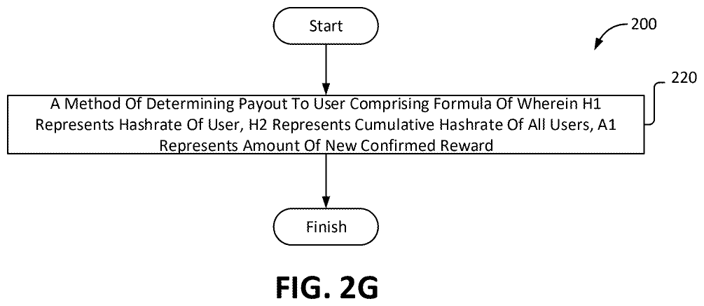

FIGS. 2A, 2B, 2C, 2D, 2E, 2F, and/or 2G illustrates a method 200 for assigning user-specific blockchain mining pool data to a computing device, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIGS. 2A, 2B, 2C, 2D, 2E, 2F, and/or 2G and described below is not intended to be limiting.

In some implementations, method 200 may be implemented in one or more processing devices (e.g., a digital processor, an analog processor, a digital Circuit designed to process information, an analog Circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

FIG. 2A illustrates method 200, in accordance with one or more implementations. An operation 202 may include providing a mining pool. Operation 202 may be performed by one or more hardware processors configured by machine-readable instructions including a module that is the same as or similar to mining pool providing module 108, in accordance with one or more implementations.

An operation 204 may include assigning a user ID to a user. Operation 204 may be performed by one or more hardware processors configured by machine-readable instructions including a module that is the same as or similar to user ID assignment module 110, in accordance with one or more implementations.

An operation 206 may include initializing the user ID on the mining pool. Operation 206 may be performed by one or more hardware processors configured by machine-readable instructions including a module that is the same as or similar to user ID Initializing module 112, in accordance with one or more implementations.

An operation 208 may include Storing user-specific data, including pool-routing information and the user ID, on a user blockchain-mining computing device. Operation 208 may be performed by one or more hardware processors configured by machine-readable instructions including a module that is the same as or similar to data Storing module 114, in accordance with one or more implementations

FIG. 2B illustrates method 200, in accordance with one or more implementations. An operation 210 may include further including the step of creating a user blockchain wallet account on a blockchain wallet application linked to the user ID. Operation 210 may be performed by one or more hardware processors configured by machine-readable instructions including a module that is the same as or similar to user blockchain wallet account creating module 116, in accordance with one or more implementations.

FIG. 2C illustrates method 200, in accordance with one or more implementations. An operation 212 may include further including the step of using the user blockchain wallet account to send and receive payments via a blockchain wallet API. Operation 212 may be performed by one or more hardware processors configured by machine-readable instructions including a module that is the same as or similar to user blockchain wallet account using module 118, in accordance with one or more implementations.

FIG. 2D illustrates method 200, in accordance with one or more implementations. An operation 214 may include further including the step of using the user blockchain-mining computing device to mine on the blockchain in a pool of third-party blockchain-mining computing devices by passing data between the pool and the user blockchain-mining computing device via one or more pool-mining APIs. Operation 214 may be performed by one or more hardware processors configured by machine-readable instructions including a module that is the same as or similar to user computing device using module 120, in accordance with one or more implementations.

FIG. 2E illustrates method 200, in accordance with one or more implementations. An operation 216 may include further including the step of providing a user blockchain-mining computing device including a protective enclosure for enclosing a power supply, one or more fans, and one or more processors. Operation 216 may be performed by one or more hardware processors configured by machine-readable instructions including a module that is the same as or similar to user providing module 122, in accordance with one or more implementations.

FIG. 2F illustrates method 200, in accordance with one or more implementations. An operation 218 may include further including a method of determining payout to a user including the formula of dividing the hashrate of a user by the cumulative hashrate of all users and multiplying the product thereof by the difference between a new confirmed reward and the previous confirmed reward. Operation 218 may be performed by one or more hardware processors configured by machine-readable instructions including a module that is the same as or similar to payout determination module 124, in accordance with one or more implementations.

FIG. 2G illustrates method 200, in accordance with one or more implementations. An operation 220 may include further including a method of determining payout to a user including the formula of wherein h1 represents the hashrate of the user, h2 represents the cumulative hashrate of all users, a1 represents the amount of a proportional reward. A2 may represent the amount of a previous confirmed reward. Operation 220 may be performed by one or more hardware processors configured by machine-readable instructions including a module that is the same as or similar to payout determination module 124, in accordance with one or more implementations.

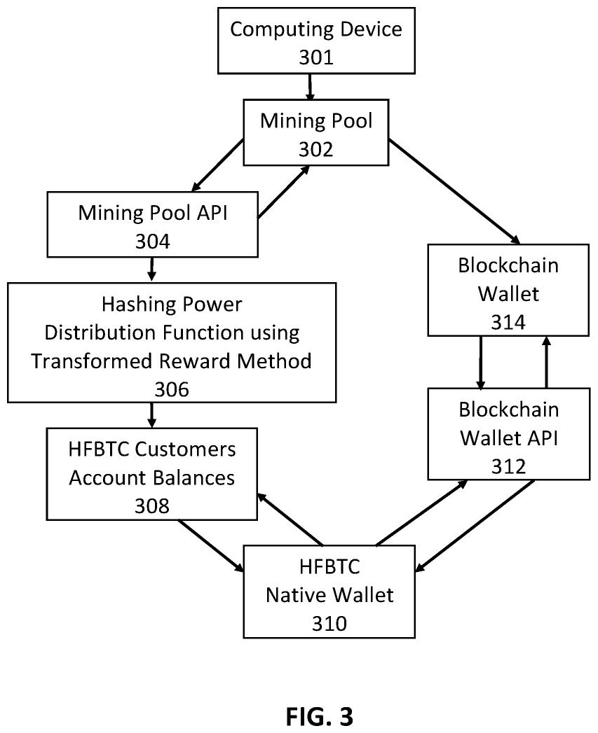

FIG. 3 illustrates a software flowchart for practicing a method according to embodiments of the present invention. A computing device 301 can be applied to a computing platform 102 to pre-configure the computing platform 102 with machine-readable instructions that execute at least one or more instruction modules 106, computer program modules 130, mining pool providing modules 108, user ID assignment modules 110, user ID initializing modules 112, data storing modules 114, user blockchain wallet account creating modules 116, user blockchain wallet account using modules 118, user computing device using modules 120, user providing modules 122, and payout determination modules 124. The computing device 301 connects to a central mining pool 302 account with unique worker ID, wherein hashing power is converted to a reward. Computing device 301 workers, with their associated unique worker ID, contribute to the total combined hashing power through a mining pool API 304. The information gathered on the mining pool API is called and stored on a job database that resides within the computing platform 102. A hashing power distribution function using a transformed reward method 306 determines payout by measuring the hashrate of the entire network divided by the hashrate of the specific worker, then disperses the reward in a proportional amount based on worker contribution. The reward is posted to a specific customer account balance 308. Balances are then recorded and associated with individual customer's accounts which appears in their native wallet 310. Before a transfer of funds is executed, the native wallet 301 must ingest information from a blockchain wallet API 312 that is shared with a blockchain wallet 314. Data generated by the blockchain wallet 314 is recorded and displayed through the blockchain wallet API 312. Rewards generated by the network are temporarily stored in the mining pool 302 before sending to another third party blockchain wallet 314.

The hashing algorithm in the transformed reward method herein uses the change in the confirmed reward values to determine the total network reward over an interval of time. The transformed reward algorithm assigns a value to the user based on hash rate contribution during on a specific block. This allows rewards to be distributed to the users at the time of confirmation, instead of waiting for additional confirmations as taught in the prior art. By advancing the distribution timing of cryptocurrency funds to users by way of the transformed reward algorithm, payout is produced earlier when assessing the value to the user based on their computing contribution, referred to herein as hash rate, during a specific interval of time, referred to herein as a block.

### Example of Prior Art Method

Unique worker ID #1 is mining cryptocurrency using a computing device. ID #1 is in a mining pool with ten (10) other unique worker ID's. Based on the combined computing power of the pool, it is determined that each worker ID is contributing 10 hashes per second for a total network hash rate of 100 hashes per second mining on the blockchain. Therefore, ID #1 is contributing 10% of the hash rate contribution, along with all other worker ID's in this example. ID #1's earned cryptocurrency is not distributed to him until it has been confirmed on a predetermined number of blocks. ID #1's contribution, commonly referred to as an unconfirmed reward, is allocated at the time the block is found, not at the time of a new confirmed reward.

### Example of Transformed Reward Method

Unique worker ID #1 is mining cryptocurrency using a computing device. ID #1 is in a mining pool with ten (10) other unique worker ID numbers. Based on the combined computing power of the pool, it is determined that each unique worker ID is contributing 10 hashes per second for a total network hash rate of 100 hashes per second mining on the blockchain. Therefore, ID #1 is contributing 10% of the hash rate contribution, along with all other unique worker ID's in this example. ID #1 has his earned cryptocurrency distributed to him in an advanced timeframe by means of an additional layer of technology, referred to herein as a transformed reward method. This transformed reward method allocates ID #1's contribution at the time of a new confirmed reward, regardless of hash rate at the time the block is found using the unconfirmed reward. The transformed reward method can be configured to determine confirmed reward payout to a user in an advanced timeframe by dividing the hashrate of a user by the cumulative hashrate of all users at the time of a new confirmed reward, and multiplying the confirmed reward payout by the difference between a new confirmed reward and the previous confirmed reward.

### Combined Alternate Example

The network has 10 users each contributing 10 hashes per second for a total network hash rate of 100 hashes per second mining on the blockchain. At the end of each block, there will be a new confirmed reward. Instead of determining contribution of the block at the time of mining, the current hash rate is captured to determine the confirmed reward, not the unconfirmed reward. If a reward of 100 units of cryptocurrency is confirmed to the network, each user shall be awarded 10 units of cryptocurrency immediately.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for assigning user-specific blockchain mining pool data to a computing device, comprising;
one or more computing platforms with electronic storage configured to communicate with one or more remote platforms;
wherein the one or more computing platforms are pre-configured with machine-readable instructions to execute at least one or more module selected from the group consisting of instruction modules, computer program modules, mining pool providing modules, user ID assignment modules, user ID initializing modules, data storing modules, user blockchain wallet account creating modules, user blockchain wallet account using modules, user computing device using modules, user providing modules, and payout determination modules; and
wherein the at least one payout determination module comprises a transformed reward method.

2. The system of claim 1, wherein the data storing module is configured to store user-specific data on a user blockchain-mining computing device comprising and application specific integrated circuit.

3. The system of claim 1, wherein the user blockchain wallet account creating module is configured to create a user blockchain wallet account on a blockchain wallet application linked to a user ID.

4. The system of claim 3, wherein the user blockchain wallet account using module is configured to use the user blockchain wallet account to send and receive payments via a blockchain wallet API.

5. The system of claim 1, wherein the user computing device using module is configured to mine on the blockchain in a pool of third-party blockchain-mining computing devices by passing data between the pool and the user blockchain-mining computing device via one or more pool-mining APIs.

6. The system of claim 1, wherein the transformed reward method is configured to determine confirmed reward payout to a user in an advanced timeframe by dividing the hashrate of a user by the cumulative hashrate of all users at the time of a new confirmed reward, and multiplying the confirmed reward payout by the difference between a new confirmed reward and the previous confirmed reward.

7. The system of claim 1, wherein the one or more computing platforms and one or more remote platforms are operatively linked via one or more electronic communication links.

8. The system of claim 7, wherein the one or more computing platforms and one or more remote platforms are selected from the group consisting of a server, a desktop computer, a laptop computer, a handheld computer, a tablet computing platform, a NetBook, a Smartphone, a gaming console, and mixtures thereof.

9. A non-transitory computer-readable storage medium, configured with instructions executable by one or more processors to cause the one or more processors to assign user-specific blockchain mining pool data to a computing device, by;
applying a computing device to a computing platform to pre-configure the computing platform with machine-readable instructions that execute at least one or more instruction modules, computer program modules, mining pool providing modules, user ID assignment modules, user ID initializing modules, data storing modules, user blockchain wallet account creating modules, user blockchain wallet account using modules, user computing device using modules, user providing modules, and payout determination modules;
connecting the computing device to a central mining pool account with a unique worker ID, wherein hashing power is converted to a reward;
determining the unique worker ID contribution to the total combined hashing power through a mining pool API;
storing the information gathered on the mining pool API on a job database residing within the computing platform, and;
determining a reward using a transformed reward method configured to determine confirmed reward payout to a user in an advanced timeframe by dividing the hashrate of a user by the cumulative hashrate of all users at the time of a new confirmed reward, and multiplying the confirmed reward payout by the difference between a new confirmed reward and the previous confirmed reward.

10. The storage medium of 9, further comprising:
calculating a proportional reward in a proportional amount based on the unique worker ID contribution, and;
posting the proportional reward to a customer account balance.

11. The storage medium of claim 10, further comprising:
recording the customer account balance in a native wallet;
ingesting information from a blockchain wallet API that is shared with a blockchain wallet, and;
dispersing the proportional reward to the native wallet.

12. The storage medium of claim 11, further comprising:
recording and displaying data generated by the blockchain wallet through the blockchain wallet API,
temporarily storing the proportional reward in the central mining pool account, and;
sending the proportional award to at least one third party blockchain wallet.

13. The storage medium of claim 9, further comprising one or more remote platforms operatively linked via one or more electronic communication links with the one or more computing platforms.

14. The storage medium of claim 13, wherein the one or more computing platforms and one or more remote platforms are selected from the group consisting of a server, a desktop computer, a laptop computer, a handheld computer, a tablet computing platform, a NetBook, a Smartphone, a gaming console, and mixtures thereof.

15. A method for assigning user-specific blockchain mining pool data to a computing device, comprising:
applying a computing device to a computing platform to pre-configure the computing platform with machine-readable instructions that execute at least one or more instruction modules, computer program modules, mining pool providing modules, user ID assignment modules, user ID initializing modules, data storing modules, user blockchain wallet account creating modules, user blockchain wallet account using modules, user computing device using modules, user providing modules, and payout determination modules;
connecting the computing device to a central mining pool account with a unique worker ID, wherein hashing power is converted to a reward;
determining the unique worker ID contribution to the total combined hashing power through a mining pool API;
storing the information gathered on the mining pool API on a job database residing within the computing platform, and;
determining a reward using a transformed reward method configured to determine confirmed reward payout to a user in an advanced timeframe by dividing the hashrate of a user by the cumulative hashrate of all users at the time of a new confirmed reward, and multiplying the confirmed reward payout by the difference between a new confirmed reward and the previous confirmed reward.

16. The method of claim 15, further comprising:
calculating a proportional reward in a proportional amount based on the unique worker ID contribution, and;
posting the proportional reward to a customer account balance.

17. The method of claim 16, further comprising:
recording the customer account balance in a native wallet;
ingesting information from a blockchain wallet API that is shared with a blockchain wallet, and;
dispersing the proportional reward to the native wallet.

18. The method of claim 17, further comprising:
recording and displaying data generated by the blockchain wallet through the blockchain wallet API,
temporarily storing the proportional reward in the central mining pool account, and;
sending the proportional award to at least one third party blockchain wallet.
